(19) United States
(12) Patent Application Publication
(10) Pub. No.: US 2026/0359281 A1
(43) Pub. Date: Nov. 12, 2026

(54) Systems, Methods and Computer Readable Media for Comparing Structured Data

(71) Applicant: Xero Limited, Te Aro, Wellington (NZ)

(72) Inventors: Lena Plaksina, Te Aro, Wellington (NZ); Dan Jacka, Te Aro, Wellington (NZ); Ilonke Pretorius, Te Aro, Wellington (NZ)

(21) Appl. No.: 19/488,339

(22) PCT Filed: May 30, 2024
(86) PCT No.: PCT/NZ2024/050060

§ 371 Date: Nov. 26, 2025

(30) Foreign Application Priority Data
May 30, 2023 (AU) 2023901691

(51) Int. Cl. G06F 16/22

(52) U.S. Cl. CPC G06F 16/2272

(57) ABSTRACT

A method comprises determining a first data object and a second data object; and for each, separating the respective data object into one or more key-value pairs, and for each key-value pair: determining if the object type of the value is a value type object or a reference type object, if a reference type object, determining whether the reference type object value can be separated into key-value pairs, and if so, separating the reference type object value into one or more key-value pairs. The method further comprises comparing the first data object with the second data object, wherein said comparing comprises, for each value that is a value type object in the one or more key-value pairs of the first and second objects, comparing a value of a key-value pair of the first object with a corresponding value of the corresponding key-value pair in the second object.

### CROSS-REFERENCE TO RELATED APPLICATION(S)

This application is a national stage 371 application of International Patent Application Serial No. PCT/NZ2024/050060, filed on May 30, 2024, which claims priority to and the benefit of Australian Patent Application Serial No. 2023901691, filed May 30, 2023, the entire disclosures of which are hereby incorporated by reference.

### TECHNICAL FIELD

Embodiments generally relate to systems, methods and computer readable media for comparing structured data, and in some embodiments, for deconstructing structured data objects to enable comparison of the structured data.

### BACKGROUND

Existing tooling for performing comparisons on software code typically includes performing a direct comparison of the code itself, or performing a direct comparison of the code results, such as the payload that generates once the code is run. However, many codes and extensions produce complex results which may include a plurality of varying data types. In such cases where complex results include data types that are not comparable, a direct comparison of the entire contents of a complex result using compare extensions cannot be performed where the result includes structured data objects.

Serialisation is the process of converting the state of an object into a form that can be persisted or transported, and deserialisation converts the stream back into an object. In some circumstances, objects are serialised, for example, into a string, and there is no suitable deserialiser available. Objects that can be serialised but not deserialised present problems for comparison. Standard compare functions and extensions do not provide any meaningful comparison of structured data objects. Using standard compare functions for serialised structured data objects would typically involve comparing a string, which will often result in inaccurate comparison mismatches. For example, standard serialisation mechanisms used in AjaxPro turns each object into a single string, and a comparison mechanism which is applied to compare two structured objects would almost always result in an unsuccessful comparison due to format and syntactical differences. That is, a mismatch will be flagged on almost any comparison due to the nature of structured data objects that exist within the results. Even if a custom comparison extension exists that can accurately compare two instances of a structured data object to determine whether they are equivalent, when a structured data object is serialised as a string, the custom comparison extension won't be able to understand the object's structure without deserialising the string before it's parsed through the extension. In some cases, the type of objects that a string contains (or even whether they are serialised objects or just regular strings) is unknown. As such, there is no mechanism for deserialising serialised structured objects.

Existing methods of parsing the entire result string for patterns and deconstructing it by hand are time intensive and laborious. Moreover, the degree of accuracy in flagging mismatches when comparing structured data is low. Custom structured data objects of reference type objects require specific comparison functions to be written for each object, since there is no standard format or number of nested objects.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

Some embodiments relate to a computer-implemented method comprising: determining a first data object and a second data object; for each of the first and second data objects: separating the respective data object into one or more key-value pairs; and for each key-value pair: determining if the object type of the value is a value type object or a reference type object; responsive to determining that the value is a reference type object, determining whether the reference type object value can be separated into key-value pairs; and responsive to determining that the reference type object value can be separated into key-value pairs, separating the reference type object value into one or more key-value pairs; and comparing the first data object with the second data object, wherein said comparing comprises, for each value that is a value type object in the one or more key-value pairs of the first and second objects, comparing a value of a key-value pair of the first object with a corresponding value of the corresponding key-value pair in the second object.

In some embodiments, where the reference type object value cannot be separated into key-value pairs, the method may return a false value. If the reference type object value cannot be separated into key-value pairs, the method may return a null value.

The determined reference type object value may be defined as a data object. The method may iteratively repeat the method until no further reference type object values can be separated into key-value pairs. In some embodiments, the method may further comprise deserialising the first data object and the second data object. The first data object and the second data object may be serialised. The first data object and second data object may each be serialised by conversion to a string.

Comparing the value of the key-value pair of the first object with a corresponding value of the corresponding key-value pair in the second object may include performing a direct comparison of values to determine if they are equal.

In some embodiments, performing a direct comparison of values may include applying a comparison function over the values. If the values are not determined to be equal, the method may generate a mismatch for the values in the first data object and the second data object.

Generating a mismatch may include generating a mismatch object.

An error may be thrown if a mismatch is generated for the values in the first data object and the second data object. Separating the data object into one or more key-value pairs may be performed in parallel for each data object.

In some embodiments, strings may be defined as a value type object. The key-value pairs may define a dictionary. The first data object and the second data object may each be a top-level object. After determining that the reference type object value can be separated into key-value pairs, the method may include defining the reference type object value as a nested object.

The value type object may be one of an integer, float, string, character, Boolean, or date. The reference type object may be an enumerable object. The reference type object may be any one of an array, list, stack, queue, map or table.

In some embodiments, the method may include, for each data object, converting the object into JSON tokens before separating into key-value pairs. The method may be configured for use with an AjaxPro generated AjaxResult.

Some embodiments relate to a non-transient computer-readable storage medium storing instructions which, when executed by a processing device, cause the processing device to perform the method of any one of the methods described herein.

Some embodiments relate to a computing device comprising: the non-transient computer-readable storage medium described herein; and a processor configured to execute instructions stored in the non-transient computer-readable storage medium.

Some embodiments relate to a computer-implemented method comprising: determining a first data object and a second data object; for each of the first and second data objects: separating the respective data object into one or more key-value pairs; and for each key-value pair: determining if the object type of the value is a value type object or a reference type object; responsive to determining that the value is a reference type object, determining whether the reference type object value can be separated into key-value pairs; and responsive to determining that the reference type object value can be separated into key-value pairs, separating the reference type object value into one or more key-value pairs.

In some embodiments, the method may include iteratively repeating the method until no further reference type object values can be separated into key-value pairs. The method may include, for each value that is a value type object, comparing the value of the key-value pair of the first object with a corresponding value of the corresponding key-value pair in the second object.

Some embodiments relate to a computer-implemented method for deserialising an object, comprising: determining a data object to be deserialised; separating the data object into one or more key-value pairs; for each key-value pair: determining if an object type of a value of the key-value pair is a value type object or a reference type object; responsive to determining that the value is a reference type object, determining whether the reference type object value can be separated into key-value pairs; and responsive to determining that the reference type object value can be separated into key-value pairs, separating the reference type object value into one or more key-value pairs; and returning a deserialised object.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF THE DRAWINGS

Various ones of the appended drawings merely illustrate example embodiments of the present disclosure and cannot be considered as limiting its scope.

FIG. 1 is a process flow diagram of a method for comparing a first data object and a second data object, according to some embodiments;

FIG. 2 is a schematic diagram showing the breakdown of a first data object and a second data object into key-value pairs, according to some embodiments;

FIG. 3 is a process flow diagram of a recursive method used for comparing a first data object and a second data object, according to some embodiments;

FIG. 4 is a schematic diagram showing a visual representation of the recursive method of FIG. 3, applied to structured data objects, according to some embodiments;

FIG. 5 is a schematic diagram illustrating the deconstruction of a structured data object which includes nested objects, according to some embodiments;

FIG. 6 is a process flow diagram showing a recursive method for comparing values within a first object and a second object, according to some embodiments;

FIG. 7 is a block diagram illustrating the comparison of a first data object and a second data object, according to some embodiments; and FIG. 8 is a block diagram of an example system configured to perform the method depicted in any one of FIGS. 1, 3 and 6.

### DETAILED DESCRIPTION

Embodiments generally relate to computer-implemented methods, systems, devices, and non-transitory computer-readable storage medium or media for comparing a first data object and a second data object, such as structured data objects. Structured data objects may require comparison for various reasons, for example, where they are part of software code, or their related payloads, and are being updated or modernised. A comparison of structured data enables the differences between legacy code and modernised code to be readily and accurately identified, and any mismatches between these data objects flagged. Some embodiments relate to comparing the structured data objects by breaking down each object to its base level, in order to allow the value type objects within the structured data objects to be directly compared.

The systems and methods described herein are configured to compare a first data object with a second data object. A data object may be referred to, and should be regarded as encompassing, structured data objects and/or structured data. A structured data object may refer to a data object which is constructed as an aggregate of other data objects, or components. A component may be elementary, or it may be another data structure. For example, a component of an array may be a value, such as a number, or it may be a record, character string, or another array.

A structured data object may be of fixed size, and have a fixed number of components for example, if the number of components is invariant during its lifetime. In some embodiments, the data object may be a fixed size array record. In some embodiments, the structured data object may be of variable size, having a variable number of components. Variable sized data objects may include operations or functions which add or delete components from structures. For example, variable structured data objects may include stacks, lists, sets, tables and/or files. In some embodiments, the data object may be homogenous and/or heterogeneous. For example, a data object may be homogenous where all components that make up the data object are the same type, such as where the data object is an array, set or file. The data object may be heterogeneous where one or more of its components are of different types, such as a record or list. In some embodiments, the data object may have a selection mechanism for identifying individual components of the data object.

Data objects may form part of code and/or part of a payload produced from code.

Payload may refer to any output of a function or code. Code may be referred to, and should be regarded as encompassing, source code, computer code, and/or software code. Code may encompass an entire computer program, a part of a program or object, and/or a piece of software code, for example, a function, sub-program, sub-routine and/or structured object. References to code or software code throughout the specification may refer to source code and may reference a text listing of commands or instructions written using a programming language. In some cases, code may be used to refer to source code to be compiled or assembled into an executable computer program, or after it has been processed by a compiler and made ready to run on a computer. In some embodiments, code may also be used to refer to text written for mark-up or styling languages such as, but not limited to, HyperText Markup Language (HTML) and Cascading Style Sheets (CSS). As an example, code may include text written using a programming languages including, but not limited to, Javascript, Python, Java, Ruby, C, C++, C #, and/or Perl.

A first data object and a second data object may be defined in the same programming language, or they may be defined in different programming languages. In some embodiments, the first object and the second object may be written in the same version of code or in different versions of code. For example, where systems and methods are used to compare a first object and a second object the comparison may identify syntactical differences between the two versions of the code languages through which the data objects are defined. The first data object and the second data object may be serialised data objects.

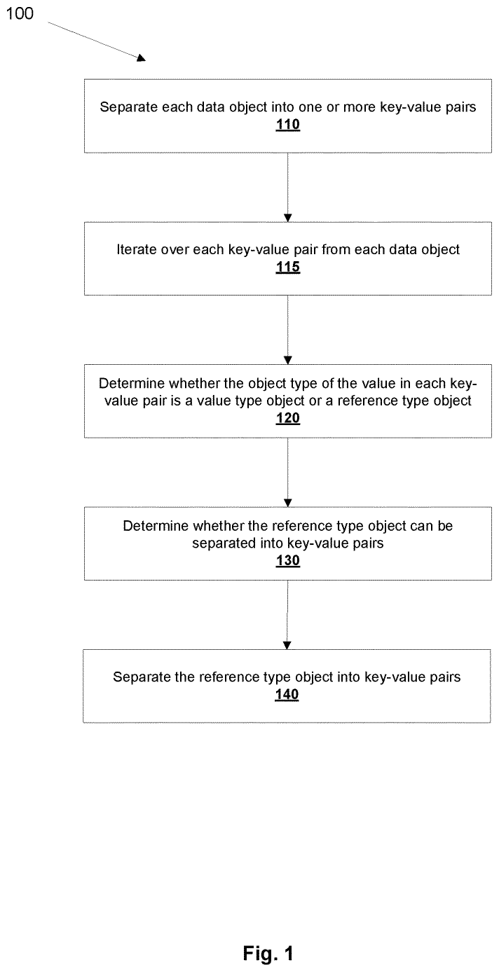

FIG. 1 is a process flow diagram of a method 100 for breaking down, or deconstructing, a first data object and a second data object. In some cases, the deconstruction may be used for comparison of the data objects. To deconstruct or deserialise a first data object 200 and a second data object 202, at 110, each data object is separated into one or more key-value pairs. A key-value pair is a data unit including two linked components: a key representing an identifier, and a value representing data linked with that identifier. For example, the key may be “colour”, and the linked value may be “green”. In another example, a key may be “objects” and the linked value may be an array of objects. Key-value pairs may also be referred to as field-value pairs, name-value pairs or attribute-value pairs. In some embodiments, key value pairs may be represented as a dictionary, list or array. In some embodiments, 110 may be applied to the top-level object of a structured data object, or it may be applied to a lower level object of a structured data object. In some embodiments, the top-level structured data object may be identified from a piece of code, an output of a function, or a payload, or it may be manually selected for comparison.

For each key-value pair, at 115, the method 100 comprises iterating over or through each key-value pair from each data object. The iteration of 115 may be performed in sequence. For example, the method 100 may iterate over key-value pairs in the first data object, and then iterate over key-value pairs in the second data object. In some embodiments, this iteration may be performed for each data object in parallel. For example, the method 100 may iterate over each key-value pair in the first and second data object at the same time. In some embodiments, iterating over each key-value pair may include assigning or labelling each key-value pair as a value type object or a reference type object as it iterates over each one. In some embodiments, before or after iterating through the key-value pairs in a data object, the components or key-value pairs may be reordered, or ordered in a particular way, such that the key-value pairs are in the same order for each of the first data object and the second data object. For example, the key-value pairs for the first object may be defined and stored in a dictionary, and the key-value pairs for the second object are then ordered in the same way as the key-value pairs in the first object.

At 120 of FIG. 1, the method 100 determines the object type of the value in the key-value pair by determining whether the values are value type objects or whether they are reference type objects. This may be performed by checking or querying the type of object for the value.

This may include checking the value type directly or confirming the value type by checking an instance, for example, by using instanceof() and/or typeof() functions. Determining the object type of the value enables the identification of nested objects and/or data within the first object 200 and/or the second object 202.

Values in the key-value pairs which are value type objects may hold data within their own memory allocation. Value type objects may also be referred to as value object types, value objects and/or value types. Value type objects are not limited to an object data type, and may refer to other data types that are values, including variables, data structures and/or enumerations, and/or composite data types such as structs. Value type objects are simple entities which, when directly compared with another value type object, possess equality based on value. In some embodiments, two value type objects may be considered equal when they have the same value, but they do not necessarily have to be the same object. Value type objects may include, but are not limited to, integers, floats, Booleans, characters, dates, and/or any numeric data types. Value type objects may be immutable.

Values in the key-value pairs which are reference type objects may represent a reference to another value. Reference type objects may also be referred to as reference object types and/or reference types. Reference type objects are not limited to an object data type, and may include other data types including classes, variables, data structures, functions and/or methods. For example, a reference to a memory address at which the other value is stored. This other value may itself be either a value type object or a reference type object. Reference type objects may be implemented using pointers and/or indicators to identify or map the reference type object to another value. Reference type objects may include, but are not limited to, classes, arrays, delegates, queues, maps, and/or strings. Reference type objects may be enumerable objects, and/or may be custom reference type objects. Reference type objects may be assigned as value type objects where there is a method of directly comparing the two objects, for example, strings may be considered value type objects. In some embodiments, strings may be considered as value type objects for the purposes of comparison as they are immutable and can be directly compared to other strings. In some embodiments, a string, which is defined by a collection of characters, cannot be separated into key-value pairs. However, a direct comparison of two strings may be performed and will not automatically return a false or null result. The default value of a reference type variable may be null. As reference type objects return a null value when they are not initialised, it is not possible to directly compare this value to another value to determine whether they are the same, and an error or a mismatch is generally thrown. In some embodiments, the method 100 may be configured to return a false value as the default value of a reference type object.

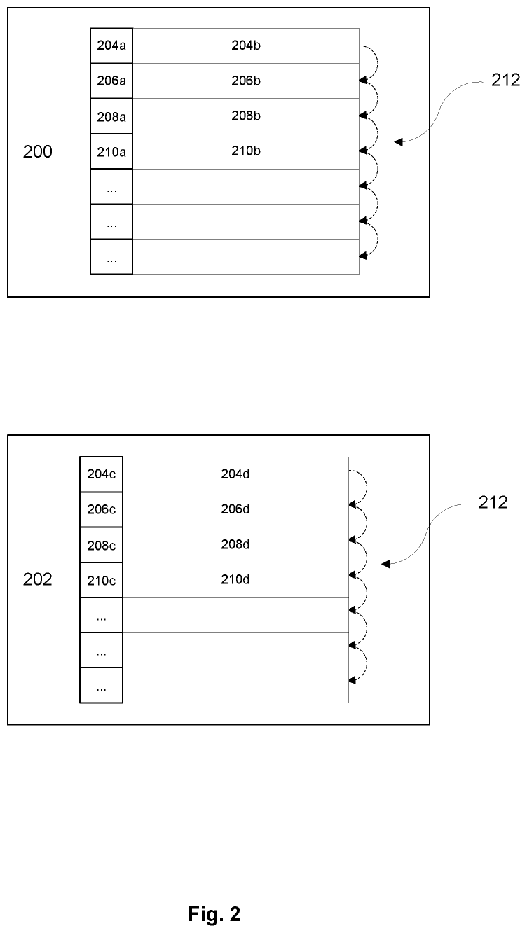

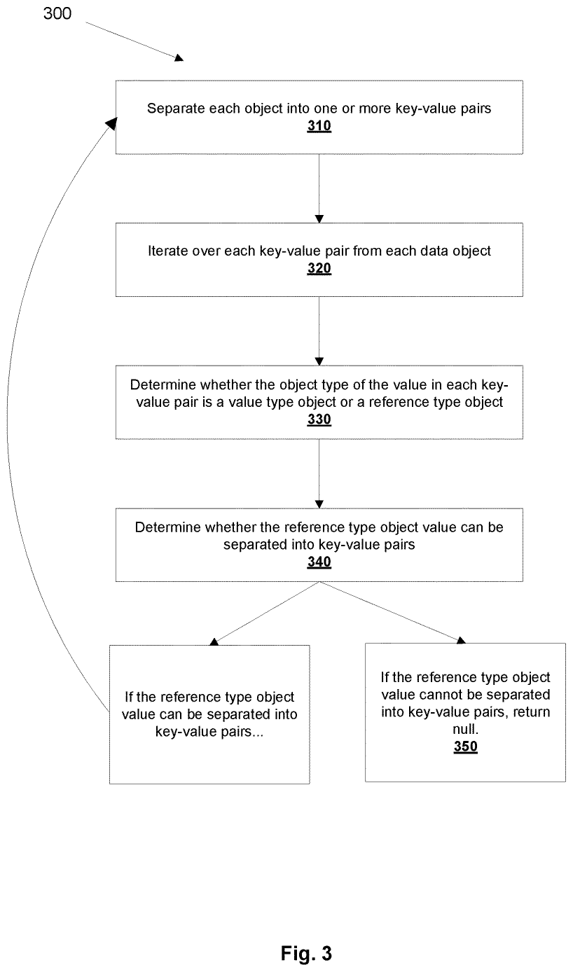

FIG. 2 is a schematic diagram showing the breakdown or decomposition of each data objects into key-value pairs. The first data object 200 is broken down into key value pairs having a key 204a, 206a, 208a, 210a, and a corresponding value assigned to each key, 204b, 206b, 208b, 210b, respectively. As the method 100 iterates over each key-value pair in the first data object 200 (where iterations are indicated by arrows 212), that value is checked to determine its value type. As shown in FIG. 2, key-value pair (key 204a, key 204b) is queried to determine whether the value 204b is a value type object or a reference type object. At the same time, a second data object is broken down into key-value pairs having a key 204c, 206c, 208c, 210c, and a corresponding value assigned to each key, 204d, 206d, 208d, 210d, respectively. As the first and second data objects are being compared, each key-value pair in the set of key value pairs for the first object will have a corresponding key-value pair in the set of key value pairs for the second object. That is, the components which make up the first object can be compared with the components that make up the second object by mapping and comparing each corresponding component. For example, in FIG. 2, key-value pair (key 204a, key 204b) in the first object 200 may correspond to key-value pair (key 204c, key 204d) in the second object 202. In some embodiments, the method 100 may iterate over these components at the same time to determine the value type of the values 204b, 204d. In some embodiments, components or key-value pairs may be reordered or ordered in a particular way before or after iterating through the key-value pairs in a data object.

In some embodiments, where the method 100 iterates over corresponding components and determines that the values are of different types, a comparison result may be returned immediately indicating a mismatch. The method 100 may be configured to end the process and make little or no attempt at breaking down the value in the first data object which is a reference type object where its corresponding value in the second data object is a value type object. In some embodiments, even if the method 100 determines that the corresponding components have values which are different types, for example, where the first object 200 has a value that is a reference type object and the second object 202 has a value which is a value type object, the method 100 may store this information but continue to break down the reference type object for the purpose of providing additional information in logs and/or mismatch objects.

Responsive to determining that the value is a reference type object, at 130 of FIG. 1, the method 100 includes determining whether the reference type object value can be separated into key-value pairs. As the value of reference type object may be null, the method 100 may check to see whether the reference type object which forms the value in a key value pair can be broken down into key-value pairs itself. At 140, based on determining that the reference type object value can be separated into key-value pairs, the reference type object value is separated into one or more key-value pairs. If the reference type object value cannot be separated into key-value pairs, a false value is returned.

The reference type object which has been separated out then forms its own dictionary of key-values pairs, and the reference type object becomes a new top-level object for that branch. By separating the reference type object out into one or more key-value pairs, the method 100 can then be applied to those key-value pairs for comparing that particular reference type object within the first object and the second object. That is, the method 100 may be iteratively repeated until no further breaking down of the first and second structured data objects can occur. For example, once the reference type object is separated out into one or more key-value pairs, the method 100 is called again for that reference type object value, which is defined as a data object. In some embodiments, the method 100 may be called within the method 100. The method 100 may be recursive. In some embodiments, the method may include, for each data object, converting the object into JSON tokens before separating into key-value pairs.

FIG. 3 is a process flow diagram of a recursive method 300 used for comparing a first object with a second object. Recursive method 300 is continued to be applied to break down one or more nested objects which exist within structured data objects to enable comparison. In 310, for each of the first and second objects, the data object is separated into key-value pairs. At 320, the method iterates over each key-value pair from each data object. The object type of each value from the key-value pair is determined as either a value type object or a reference type object in 330. At 340, where the value is determined to be a reference type object, the method 300 determines whether the reference type object can be separated into key-value pairs. If the reference type object value can be separated into key-value pairs, the method 300 calls itself, returning to 310 and applying this to the new data object which is defined by the reference type object. If the reference type object value cannot be separated into key-value pairs, at 350 a false value or a null value is returned, and that instance of the method 300 is stopped.

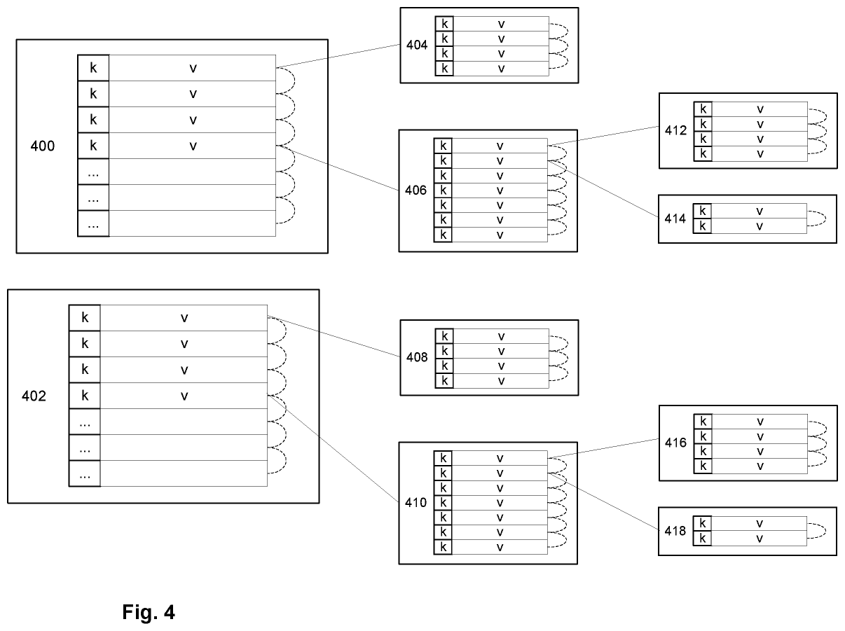

FIG. 4 is a schematic diagram showing a visual representation of the recursive method 300 being applied to structured data objects which contain nested objects. In FIG. 4, two top-level objects 400 and 402 are broken down into key-value pairs, where keys are represented by k and values are represented by v. The method 300 iterates over each value in the key-value pairs, and identifies that object 404 is a reference type object which can be further separated out into key-value pairs. It separates object 404 out into key-value pairs, and iterates over these values, but determines that no further reference type objects exist in the object 404. That is, object 404 has been broken down into its base components, and contains no nested objects. However, as the method 300 iterates over each value in the key-value pairs of original top-level data object 400, the object 406 is identified as a reference type object which can be further separated out into key-value pairs. Object 406 is separated out into key value pairs, and the method 300 iterates over each of the values in the key-value pairs of object 406 to determine if the values are value type objects or reference type objects. In this case, value 412 of object 406 is determined to be a reference type object which can be separated into key-value pairs.

Accordingly, 412 is separated into key value pairs, and the method 300 iterates over each of the values in the key-value pairs of object 412 to determine if the values are value type objects or reference type objects.

The recursive method 300 is continued to be applied to each object until there are no further objects to be broken down. In some embodiments, the recursive method 300 may be applied to multiple values at the same time. For example, after iterating through each value in a set of key-value pairs, the values which are identified as reference type objects within a first data object may be separated out into key-value pairs in parallel. That is, the recursive method 300 may have multiple instances running in parallel as it breaks down and checks each component of the structured object. In some embodiments, the recursive method 300, may be applied in sequence, exhausting one branch of breaking down objects before returning to checking the next value in the set of key-value pairs. For example, referring to FIG. 4, where the method 300 is applied to a data object 406, and a value 412 is determined to be a reference type object, the method may be immediately be applied to object 412 to break it down into key-value pairs, and iterate through those values of 412, determine that there are no further reference type objects in the values of 412, before returning to the next value 414 in the set of key-value pairs.

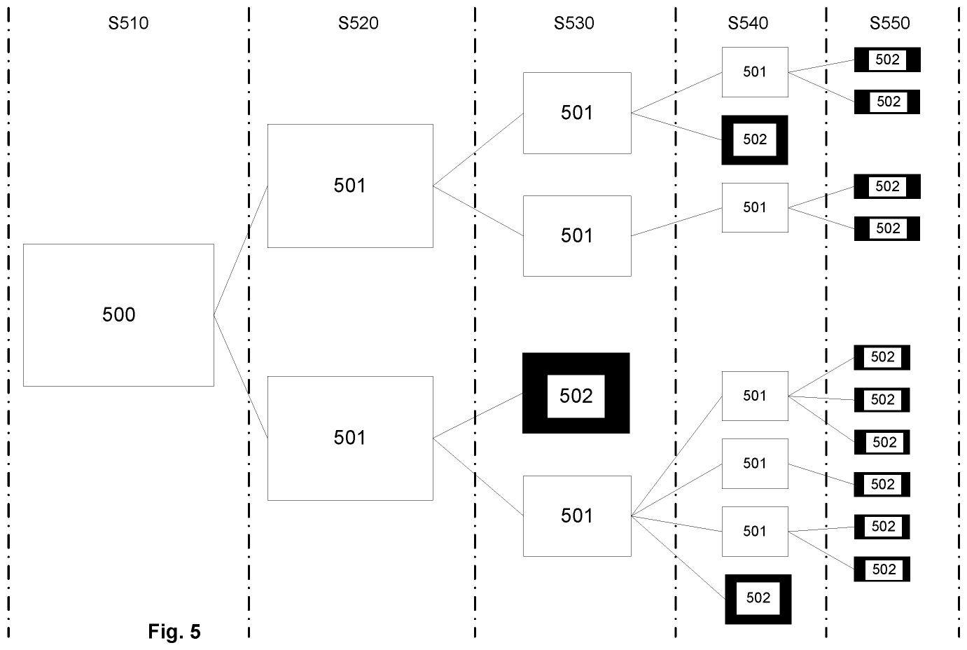

FIG. 5 provides a schematic diagram illustrating the deconstruction of structured data object 500 which has a number of nested objects, where the recursive method 300 is applied to deconstruct the structured data object 500 and separate the components of each nested structured data objects into their individual components in stages. In a first stage S510, a top-level structured data object 500 exists and is required to be compared to a second data object. Accordingly, at stage S520, structured data object 500 is separated out into two distinct reference type objects 501 by applying the recursive method 300. The reference type objects 501 have the recursive method 300 applied simultaneously to determine whether they can be broken down further. At stage S530, reference type objects 501 are broken down into further reference type objects 501 and value type objects 502. Value type objects cannot be broken down further and may be stored for later comparison after the data object is fully deconstructed. However, reference type objects 501 may each have the recursive method applied again in stage S540 to further break down the objects 501. In a final stage S550, all remaining components of the reference type objects from the previous stage are value type objects 502 which can be used for comparison. The number of stages, or occurrences over which the recursive method 300 is applied, required to deconstruct the structured data object into its base value type components may be any number, and will depend on the number of nested objects.

In some embodiments, the recursive method 300 may be applied to a first and second data object simultaneously and/or in parallel. In some embodiments, the recursive method may be applied sequentially, for example, to a first object before or after a second data object. In some embodiments, a subset of the recursive method 300 may be performed in sequence or in parallel.

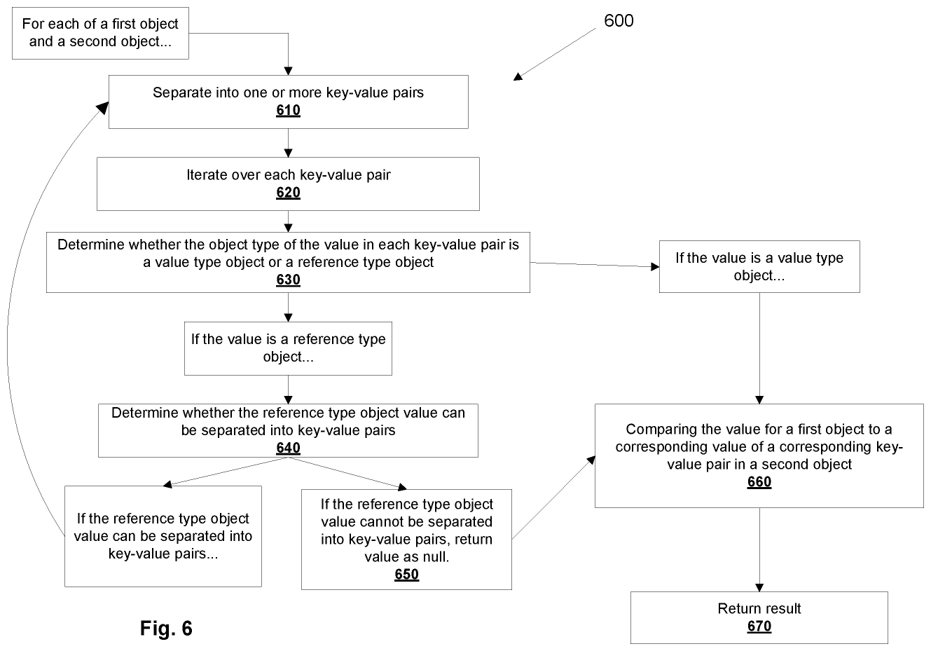

FIG. 6 is a process flow diagram of a recursive method 600 for comparing values within a first object and a second object. For example, the recursive method 600 may comprise using the recursive method of FIG. 3 for comparing values within a first object with a second object. For each of a first object and a second object, a recursive comparison method 600 is used to separate each object into one or more key value pairs at 610. At 620, each key value pair is iterated over, and each value is determined to be a value type object of a reference type object at 630. If the value is a reference type object, then it is determined whether the reference type object value can be separated into key-value pairs at 640. If the reference type object can be separated, the method reverts to 610. If the reference type object cannot be separated into key-value pairs, the value is returned as null.

However, at 630, if the value is determined to be a value type object, the method proceeds to 660, at which the value of the value type object is compared against the corresponding value of the corresponding key-value pair in the second object. By breaking down each nested object into its individual values, and then performing a comparison of those values between the first object and the second object, this allows the first and second objects to be directly compared with a higher degree of accuracy even when they contain nested objects.

In some embodiments, in 650 where the reference type object cannot be separated and the returned value is null, this returned value may be used to compare the value for a first object to a corresponding value of a corresponding key-value pair in a second object. For example, in comparing the two corresponding nested objects, there may be a desire to identify that both the first object and the second object have a null value, that is, a reference type object that cannot be further broken down, at the same location. In some embodiments, the returned value at 650 may be false. The false value may be returned immediately as a comparison result, for example, in embodiments where there is no capacity to compare custom objects. Custom objects, such as values which are of custom classes and have no enumerator may be compared by implementing a custom comparison function, which could be used in conjunction with the described method.

The comparison of a first value from the first object and a corresponding second value from the second object may be performed by directly comparing the first value and the second value. Referring back to FIG. 2, for example, value 204b of key-value pair (key 204a, key 204b), corresponds to value 204d of key-value pair (key 204c, key 204d) for the purposes of comparing first object 200 with second object 200. If values 204b and 204d are both value type objects, they may be directly compared to determine whether they are of equal value. If they are both reference type objects, values 204b and 204d will need to be separated into key-value pairs and those values from each key 204b, 204d will need to be compared. In some embodiments, the corresponding values from each object are stored as they are identified as value type objects, and a comparison is performed on all values only once the method has finished identifying all types and iterated over all key-value pairs for each object. In embodiments where the values are stored, the method may include ordering the values such that the sequence of the values for the first object appears the same as the sequence of the values for the second object. This improves the efficiency in which a direct comparison of the values can then be performed.

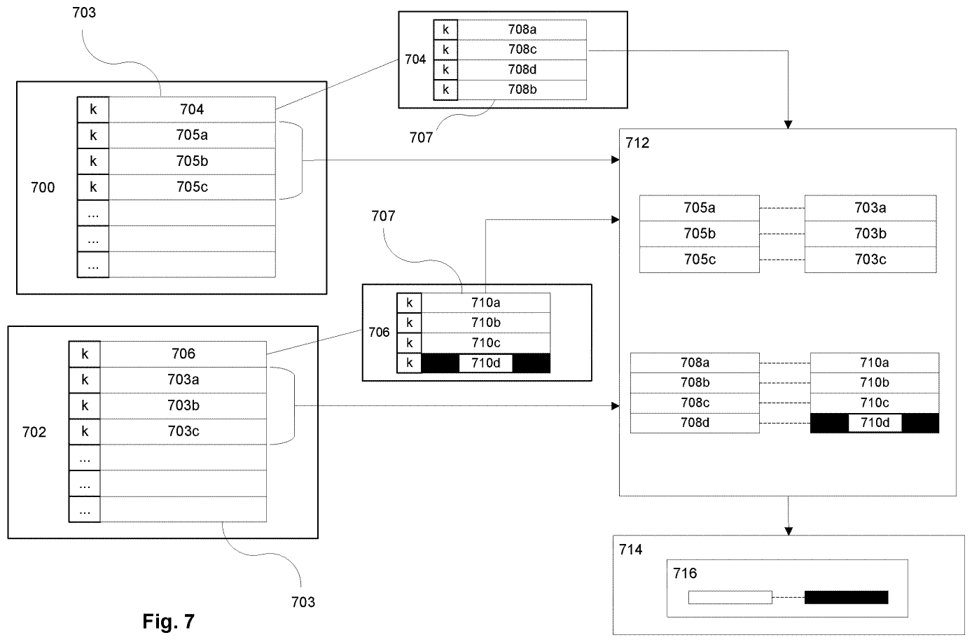

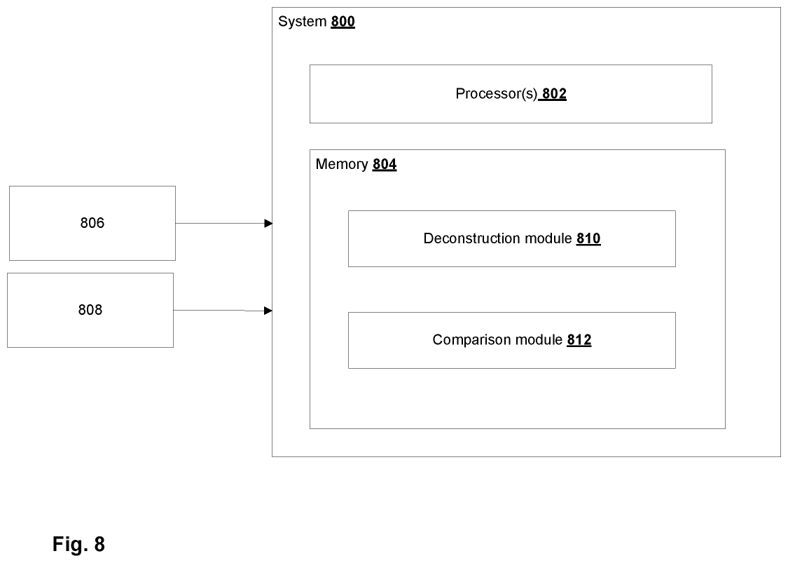

FIG. 7 is a block diagram illustrating the method 600 of a comparison of a first structured data object 700 and a second structured data object 702. Structured data objects 700 and 702 are broken down into key-value pairs 703, and the key-value pairs are iterated over to determine the object type. In the first instance, corresponding values 704 and 706 which are the first values in key-value pairs 703 are determined to be reference type object values. Accordingly, reference type objects 704 and 706 are broken down into a set of key-value pairs 707, and the key-value pairs are iterated over to determine object type. All values in the key-value pairs 707 are determined to be value type objects. Accordingly, they are provided to a comparison function 712 for direct comparison. Since there are no further values in 704 and 706 to iterate over, the iteration reverts back to key value pairs 703 to continue iterating over the list. The remaining key values of data object 700 (705a, 705b, 705c), and the remaining corresponding key values of data object 702 (703a, 703b, 703c) are determined to be value type objects. Accordingly, the value type objects from key-value pairs 703 are provided to the comparison function 712. The comparison function is then run to compare the value type object values obtained from the deconstructed structured data objects 700 and 702. The comparison function may run comparisons as sets of values are provided to it. For example, it may run a comparison on the value type object values received from data objects 704 and 706, and then at a later stage compare the value type object values received from 700 and 702.

In some embodiments, the comparison function may be designed to reorder the value type objects to apply a direct comparison. For example, the set of key-value pairs 707 which appears in reference type object 704 appears in the order 708, 708c, 708d, 708b. However, the comparison function 712 can reorder these values to ensure corresponding values are being directly compared. Reordering may be performed based on naming conventions, formatting, and/or type of value, but is not limited to such conditions. A comparison result 714 is then output from the comparison function 712 which contains all or part of the results from comparing the values of the deconstructed data objects 700 and 702. The comparison result 714 may include one or more mismatch objects 716, where a comparison returns a false value. In some embodiments, the mismatch object may include information about the false comparison, including the values which have been identified as a mismatch, and/or a description of the mismatch which flags the location or type of mismatch, but which does not reveal the actual values which have been compared.

In some embodiments, the comparison is performed at the time of identifying each value from each object, where mismatches may be stored in a log data set. In some embodiments, only a portion of a first structured data object is compared to a corresponding portion of the second structured data object. For example, a section or a subset of components of the first object and the second object may be selected for comparison, such that only specific components or key-value pairs within the selected subset are compared. A plurality of components from the first object and the second object may be selected. In some embodiments, the comparison of an upper-level set of key-value pairs is performed before a comparison of a low-level set of key-value pairs in a nested object.

Structured data objects may exist within payloads which are being compared. In some embodiments, the methods described herein may be used in conjunction with methods for comparing code and/or payloads and/or output(s) of functions, for example, to enable methods for comparing code to compare complex and structured data objects.

FIG. 8 is a block diagram of a system 800 configured to perform the method 600 of FIG. 6, according to some embodiments. The system 800 comprises one or more processor(s) 802 and/or memory 804. The system is configured to receive, generate, or determine a first data object 806 and a second data object 808 to be compared. The system 800 may determine the first data object 806 and the second data object 808 from an external source, such as a database, network, or input. In some embodiments, the system may be configured to receive the first data object 806 and the second data object 808 for processing. In some embodiments, the system may be configured to receive first code and second code and extract at least one data object from each of the first code and the second code. The processor(s) 802 may comprise one or more microprocessors, central processing units (CPUs), application specific instruction set processors (ASIPs), application specific integrated circuits (ASICs) or other processors capable of reading and executing instruction code.

The memory 804 may comprise one or more volatile or non-volatile memory types. For example, memory 804 may comprise one or more of random access memory (RAM), read-only memory (ROM), electrically erasable programmable read-only memory (EEPROM) or flash memory. The memory 804 is configured to store program code accessible by the processor(s) 802. The program code comprises executable program code modules. In other words, memory is configured to store executable code modules, when executed by the processors to cause the system to perform certain functionalist. For example, memory 804 may comprise a deconstruction module 810 and/or a comparison module 812. A code module may be a collection of computer executable or computer intelligible code, that when executed by a processor, causes the processor to perform processes, action or functionalities, such as the processes, actions or functionalities of the methods described herein.

In some embodiments, deconstruction module 810 is configured to perform method 100, method 300 and/or at least part of method 600. Comparison module 812 is configured to perform at least part of method 600. For example, the deconstruction module 810 may be configured to perform the parts of method 600 which relate to deconstructed the data objects 806, 808 into their key-value pairs (610, 620, 630, 640, 650), and the comparison module 812 may be configured to perform the parts of method 600 which compare the values of the corresponding values in the key-value pairs from the data objects 806, 808 (660 and 670). In some embodiments, the deconstruction module 810 may be part of the comparison module 812, or the comparison module 812 may be part of the deconstruction module 810. In some embodiments, the deconstruction module 810 and the comparison module 812 may be the same module or separate modules.

In some embodiments, the methods described herein may be used for comparing code which contain several fields. In one example, the methods may be used to compare AjaxPro generated AjaxResults. AjaxResults contain several fields, including Is Valid (bool), Result (HTML string), Data (which may be a serialised enumerable object, potentially nested within an unknown deepest nesting level), and Exception (string). Comparing the Data field of an AjaxResult is difficult due to the structure of the Data field. The Data field has deep nesting levels, and no defined set of expected data structures or number of nesting levels. The Data field of an AjaxResult contains reference type objects that need to be deconstructed before a comparison can be performed. The recursive methods for comparing data objects can be applied to the Data field of the AjaxResult to compare with another AjaxResult. In some embodiments, the method can be used in conjunction with other distinct comparison methods to compare the other fields of the AjaxResult. For example, the Is Valid and Exception fields can be compared using CompareTo and string.Compare functions. The Result comparison can be performed by comparing the payloads and/or using HTML Compare and text Compare functions.

Methods of comparing a first structured data object and a second structured data object can be used in a number of applications to compare enumerable data structures. The recursive nature of the methods provide distinct technical advantages in that the method is able to be continually called until no further deconstructions of reference type objects are able to be performed, allowing the methods to be applied to break down structured data objects even where the deepest nesting level is unknown. Since the method works to recursively break down each reference type object into key-value pairs, the method effectively and efficiently iterates through each object, breaking it down into its base components until only value type objects are left, or until it cannot be broken down into further key-value pairs. The deconstruction, or deserialization, of structured data objects enables a direct comparison of values to be performed to compare structured data objects within code with an improved accuracy and reduced false mismatches due to formatting or syntactic differences.

Additionally, the methods described herein can provide a way of deserializing or deconstructing deeply nested enumerable objects that have undergone conversion into strings. The methods may be applied to any serialised object, particularly in cases where the serialisation of an object has no mechanism to revert the serialised object, and/or where libraries are not configured to deal with or parse such serialised objects.

Advantageously, the comparison methods provide the ability to compare nested collections of objects key by key, which are nested to any level. Comparisons can be performed on key-value pairs where the key is a string and the value is either a value type object (such as an integer, string, Boolean, character), or the value is an enumerable reference type object. The method can be applied to enable deserialization of any serialised object that has no deserialisation mechanism to make deserialisation simple, and enable deserialisation of any unconventionally serialised objects that cannot be deserialised. A more comprehensive comparison is provided that reduces the manual and time-consuming process of breaking down objects in code by hand or trawling through logs, enabling mismatches to be efficiently flagged and logged, even for structured data. This is particularly advantageous for applications in code modernisation, uplifting and/or updating, where formatting and syntactic differences are important.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A computer-implemented method comprising:
determining a first data object and a second data object;
for each of the first and second data objects:
separating the respective data object into one or more key-value pairs; and
for each key-value pair:
determining if an object type of a value is a value type object or a reference type object;
responsive to determining that the value is a reference type object, determining whether the reference type object value can be separated into key-value pairs; and
responsive to determining that the reference type object value can be separated into key-value pairs, separating the reference type object value into one or more key-value pairs; and
comparing the first data object with the second data object, wherein said comparing comprises, for each value that is a value type object in the one or more key-value pairs of the first and second objects, comparing a value of a key-value pair of the first object with a corresponding value of the corresponding key-value pair in the second object.

2. The method of claim 1, wherein if the reference type object value cannot be separated into key-value pairs, returning a false value; or
wherein if the reference type object value cannot be separated into key-value pairs, returning a null value.

3. (canceled)

4. The method of claim 1, wherein the determined reference type object value is defined as a new data object.

5. The method of claim 1, wherein the method calls itself one or more times after separating the reference type object into one or more key-value pairs.

6. The method of claim 1, further comprising iteratively repeating the method until no further reference type object values can be separated into key-value pairs.

7. The method of claim 1, further comprising deserialising the first data object and the second data object.

8. The method of claim 1, wherein the first data object and the second data object have been serialised; or
wherein the first data object and second data object have each been serialised by conversion to a string.

9. (canceled)

10. The method of claim 1, wherein comparing the value of the key-value pair of the first object with a corresponding value of the corresponding key-value pair in the second object includes performing a direct comparison of values to determine if they are equal;
wherein performing a direct comparison of values includes applying a comparison function over the values; and
wherein if the values are not determined to be equal, generating a mismatch for the values in the first data object and the second data object.

11. (canceled)

12. (canceled)

13. The method of claim 10, wherein generating a mismatch includes generating a mismatch object; and/or
wherein an error is thrown if a mismatch is generated for the values in the first data object and the second data object.

14. (canceled)

15. The method of claim 1, wherein the separating the data object into one or more key-value pairs is performed in parallel for each data object.

16. The method of claim 1, wherein strings are defined as a value type object.

17. The method of claim 1, wherein the key-value pairs define a dictionary.

18. The method of claim 1, wherein the first data object and the second data object are top-level objects.

19. The method of claim 1, wherein after determining that the reference type object value can be separated into key-value pairs, defining the reference type object value as a nested object.

20. The method of claim 1, wherein the value type object is one of an integer, float, string, character, Boolean, or date.

21. The method of claim 1, wherein the reference type object is an enumerable object; and/or
wherein the reference type object is any one of an array, list, stack, queue, map or table.

22. (canceled)

23. The method of claim 1, further including, for each data object, converting the object into JSON tokens before separating into key-value pairs.

24. The method of claim 1, wherein the method is configured for use with an AjaxPro generated AjaxResult.

25. Non-transitory computer-readable storage medium storing instructions which, when executed by a processing device, cause the processing device to perform the method of claim 1.

26. A computing device comprising:
the non-transitory computer-readable storage medium of claim 25; and
a processor configured to execute instructions stored in the non-transitory computer-readable storage medium.

27. (canceled)

28. (canceled)

29. (canceled)

30. (canceled)
